(19) United States
(12) Patent Application Publication
(10) Pub. No.: US 2002/0114910 A1
(43) Pub. Date: Aug. 22, 2002

(54) Transparent adhesive tape for transferring words or designs printed on paper

(76) Inventor: Fun-Ying Lin, Taichung (TW)

Correspondence Address: HARRISON & EGBERT, 412 MAIN STREET, 7TH FLOOR, HOUSTON, TX, 77002, US

(21) Appl. No.: 09/788,432

(22) Filed: Feb. 21, 2001

(51) Int. Cl. B32B 7/06

(52) U.S. Cl. 428/40.1; 428/906

(57) ABSTRACT

A transparent adhesive tape is formed of a transparent adhesive film and a releasing paper for holding removably the transparent adhesive film. The underside of the transparent adhesive film is coated with an adhesive and is capable of transferring thereto letters or designs printed on paper.

### FIELD OF THE INVENTION

The present invention relates generally to an adhesive tape, and more particularly to a transparent adhesive tape capable of transferring thereto words or designs which are printed on paper.

### BACKGROUND OF THE INVENTION

Once the conventional adhesive tape is attached to the surface of paper, the adhesive tape can not be easily removed from the surface of paper without defacing the paper surface to which it is attached. For this reason, it is difficult, if not impossible, to reattach the removed tape in a proper manner.

### SUMMARY OF THE INVENTION

It is the primary objective of the present invention to provide an adhesive tape which is free of the drawback of the conventional adhesive tape described above.

It is another objective of the present invention to provide a transparent adhesive tape which is capable of transferring thereto words or designs printed on paper.

In keeping with the principle of the present invention, the foregoing objectives of the present invention are attained by a transparent adhesive tape which is formed of a transparent adhesive film and a releasing paper. The transparent adhesive film is removable attached to the releasing paper.

The transparent adhesive film is capable of transferring thereto letters, words, or designs printed on paper.

The features and the functions of the present invention will be more readily understood upon a thoughtful deliberation of the following detailed description of the preferred embodiments of the present invention with reference to the accompanying drawings.

### BRIEF DESCRIPTION OF THE DRAWINGS

FIG. 1 shows a schematic view of a first preferred embodiment of the present invention.

FIG. 2 shows a schematic view of a second preferred embodiment of the present invention.

FIG. 3 shows a schematic view of a third preferred embodiment of the present invention.

FIG. 4 shows a schematic view of a fourth preferred embodiment of the present invention.

FIG. 5 shows a schematic view of a fifth preferred embodiment of the present invention.

FIGS. 6A-6C are schematic views of the process of transferring to the transparent adhesive film of the present invention letters and design printed on paper.

### DETAILED DESCRIPTION OF THE PREFERRED EMBODIMENTS

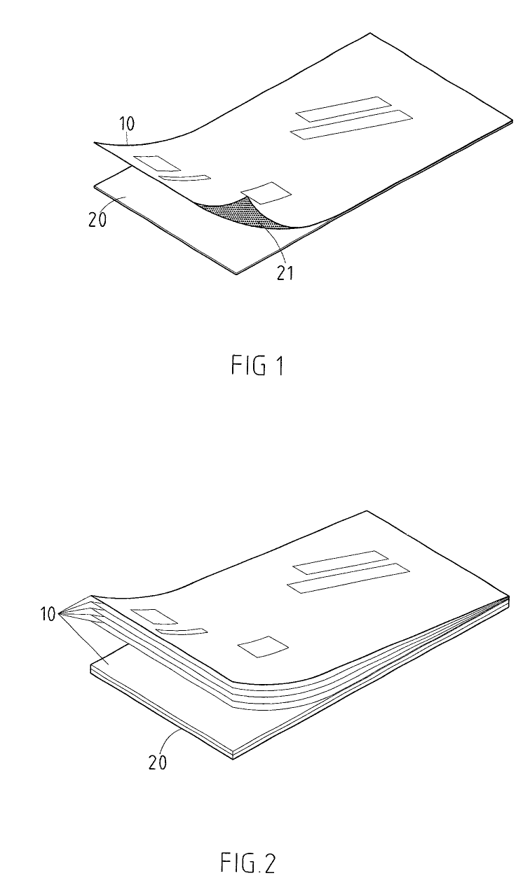

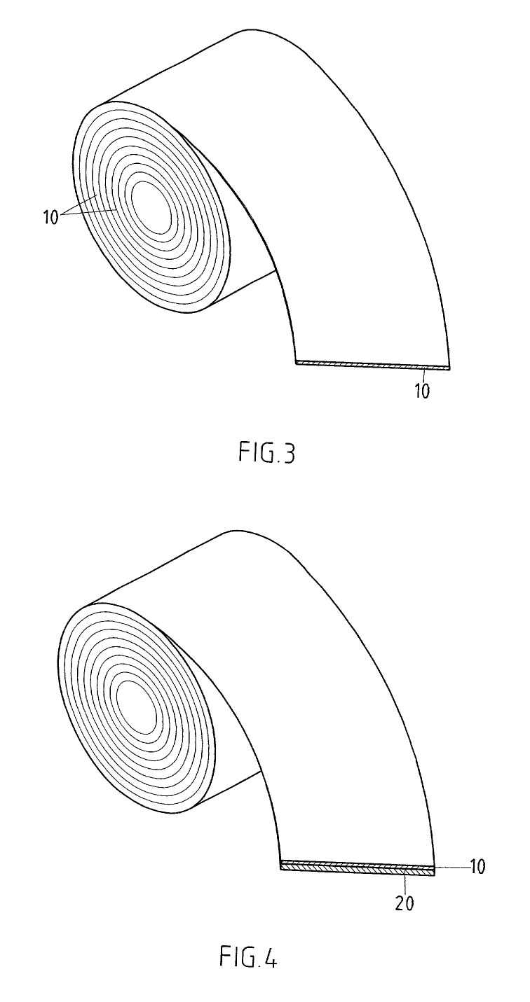

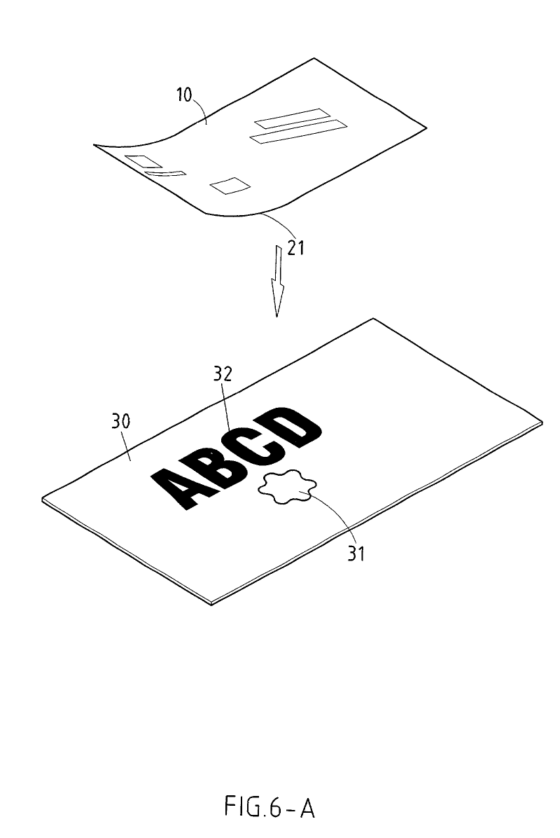

As shown in FIGS. 1-5, a transparent adhesive tape of the present invention exists in various forms, such as a single rectangular sheet, a stack of a plurality of the rectangular sheets, or a roll.

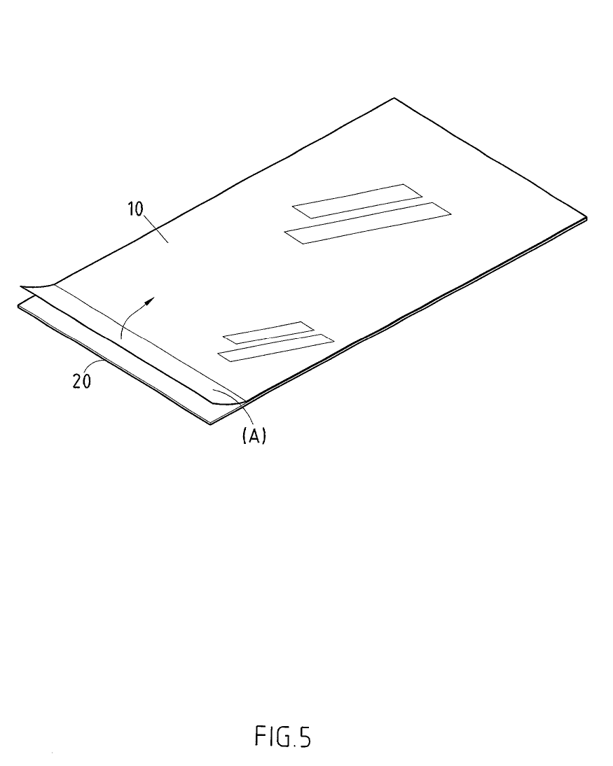

The transparent adhesive tape of the present invention is formed of a transparent adhesive film 10, as shown in FIG. 3. The transparent adhesive film 10 is coated in the underside with an adhesive 21. In addition to the transparent adhesive film 10 , the present invention is formed of a releasing paper 20 for holding removably the transparent adhesive film 10, as shown in FIGS. 1, 2, 4, and 5. The coated underside of the transparent adhesive film 10 is removably attached to the upper side of the releasing paper 20.

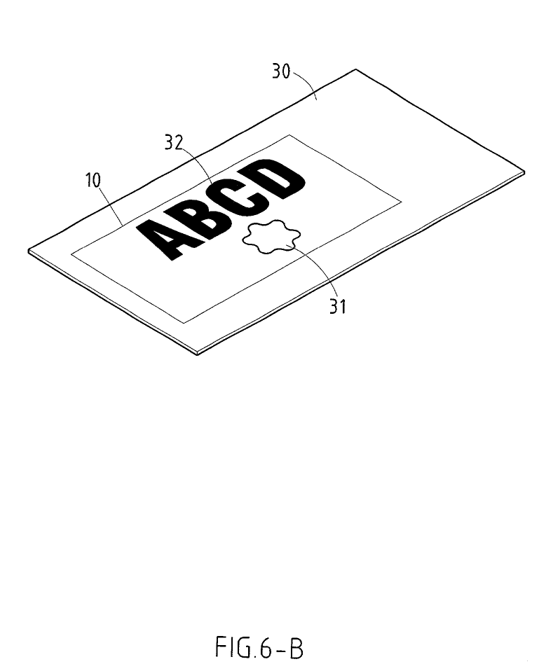

As shown in FIG. 5, the adhesive film 10 is provided with a side edge “A” which is free of the adhesive 21 to facilitate the holding of the adhesive film 10 with fingers.

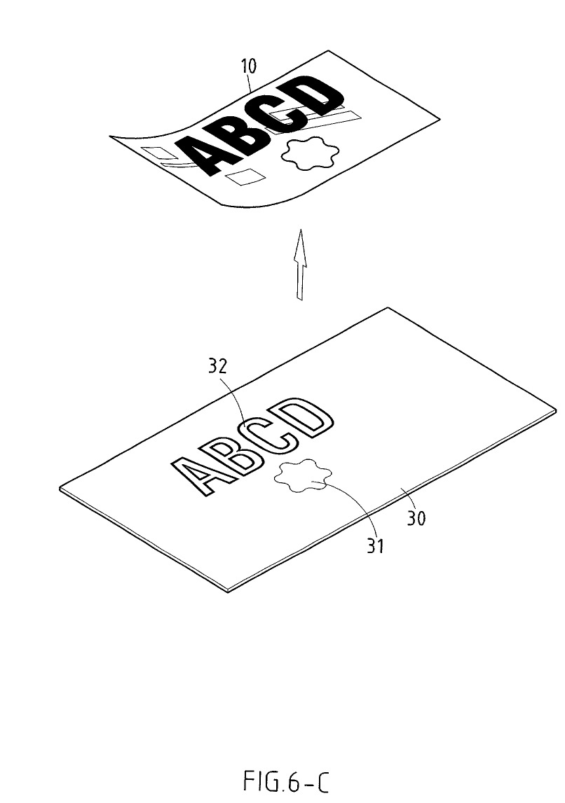

The transparent adhesive film 10 of the present invention is capable of transferring thereto lettres, words, or designs printed on paper, as illustrated in FIGS. 6A-6C. The transfer process involves a first step in which the coated side 21 of the transparent adhesive film 10 is placed on a paper surface 30 on which a design 31 and a plurality of English letters 32 are printed, as shown in FIGS. 6A and 6B. Thereafter, the upper surface of the transparent adhesive film 10 is gently rubbed with finger before the transparent adhesive film 10 is removed from the paper surface 30. As the transparent adhesive film 10 is separated from the paper surface 30, the design 31 and the letters 32 are transferred to the coated side 21 of the transparent adhesive film 10, as shown in FIG. 6C.

The embodiments of the present invention described above are to be regarded in all respects as being merely illustrative, and not restrictive. Accordingly, the present invention may be embodied in other specific forms without deviating from the spirit thereof. The present invention is therefore to be limited only by the scopes of the following appended claims.

What is claimed is:

1. A transparent adhesive tape comprising a transparent adhesive film coated in an underside thereof with an adhesive whereby said underside of said transparent adhesive film is capable of transferring thereto letters, words, or designs printed on paper.

2. The transparent adhesive tape as defined in claim 1 further comprising a releasing paper for holding removably said transparent adhesive film in such a manner that said underside of said transparent adhesive film is attached to an upper side of said releasing paper.

3. The transparent adhesive tape as defined in claim 2, wherein said transparent adhesive film and said releasing paper are equal in size and shape to each other.

4. The transparent adhesive tape as defined in claim 2, wherein said transparent adhesive film and said releasing paper have a predetermined length and are made into the form of a roll.

5. The transparent adhesive tape as defined in claim 2, wherein said transparent adhesive film is provided in the underside thereof with an adhesive-free edge.

6. The transparent adhesive tape as defined in claim 1, wherein said transparent adhesive film has a predetermined length and is made into the form of a roll.
